(19) United States
(12) Patent Application Publication
(10) Pub. No.: US 2016/0238420 A1
(43) Pub. Date: Aug. 18, 2016

(54) ELECTROMAGNETIC FLOWMETER

(71) Applicant: KABUSHIKI KAISHA TOSHIBA, Minato-ku, Tokyo (JP)

(72) Inventor: Satoshi HOJO, Tachikawa Tokyo (JP)

(21) Appl. No.: 15/031,659

(22) PCT Filed: Jan. 15, 2014
(86) PCT No.: PCT/JP2014/050581

§ 371 Date: Apr. 22, 2016

(30) Foreign Application Priority Data
Oct. 29, 2013 (JP) 2013-224262

(51) Int. Cl. G01F 1/58

(52) U.S. Cl. CPC G01F 1/586

(57) ABSTRACT

According to an embodiment, in general, an electromagnetic flowmeter includes a pipe, a detector and a flange. A fluid to be measured flows through the pipe. The detector detects the fluid to be measured. The flange includes a plurality of members. The members are integrated with the pipe with a fastener while surrounding an outer periphery of the pipe.

### FIELD

Embodiments of the present invention relate to an electromagnetic flowmeter.

### BACKGROUND

Conventionally, electromagnetic flowmeters are known, in which flanges are attached to a pipe by full-circled welding.

### CITATION LIST

### Patent Literature

Patent Literature 1: Japan Patent Application Laid-open No. 2009-288026

### SUMMARY OF THE INVENTION

### Problem to be Solved by the Invention

It is desirable that such electromagnetic flowmeters having different specifications including mount hole positions on the flanges can commonly use a part of their elements.

### Means for Solving Problem

An electromagnetic flowmeter of an embodiment, for an example, comprises a pipe, a detector and a flange. A fluid to be measured flows through the pipe. The detector detects the fluid to be measured. The flange includes a plurality of members. The members are integrated with the pipe with a fastener while surrounding an outer periphery of the pipe.

### BRIEF DESCRIPTION OF DRAWINGS

FIG. 1 is a perspective view of an example of an electromagnetic flowmeter according to a first embodiment.

FIG. 2 is a cross-sectional view of FIG. 1 along the II-II line.

FIG. 3 is a cross-sectional view of FIG. 2 along the line.

FIG. 4 is a planar view (a partial cross-sectional view) of an example of an electromagnetic flowmeter according to a second embodiment.

FIG. 5 is a planar view (a partial cross-sectional view) of an example of an electromagnetic flowmeter according to a third embodiment.

### DETAILED DESCRIPTION

Exemplary embodiments will be described below with reference to the accompanying drawings. The following embodiments include same or like constituent elements. Hence, in the following, the same or like constituent elements are given the common reference numerals, and a redundant explanation is omitted. Moreover, the following embodiments will merely illustrate examples of configurations (technical features) as well as action and effects resulting from the configurations. The present invention can also be implemented by different configurations other than the configurations disclosed in the following embodiments, and can achieve various effects (including consequential effects) obtained by the fundamental configuration (technical features).

### First Embodiment

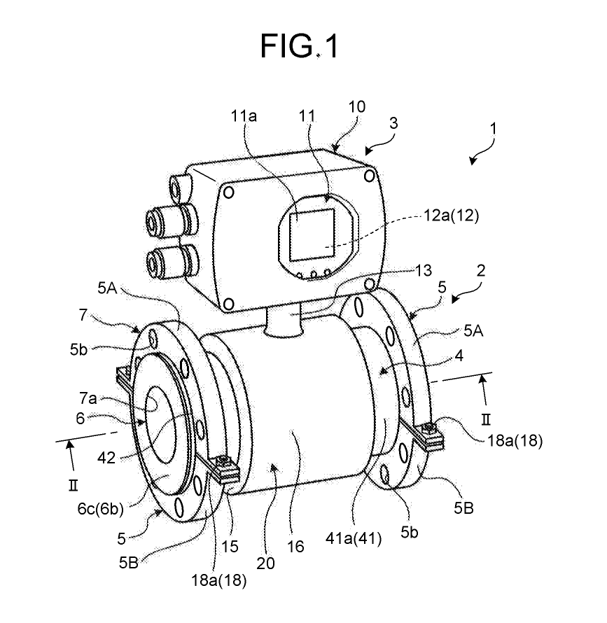

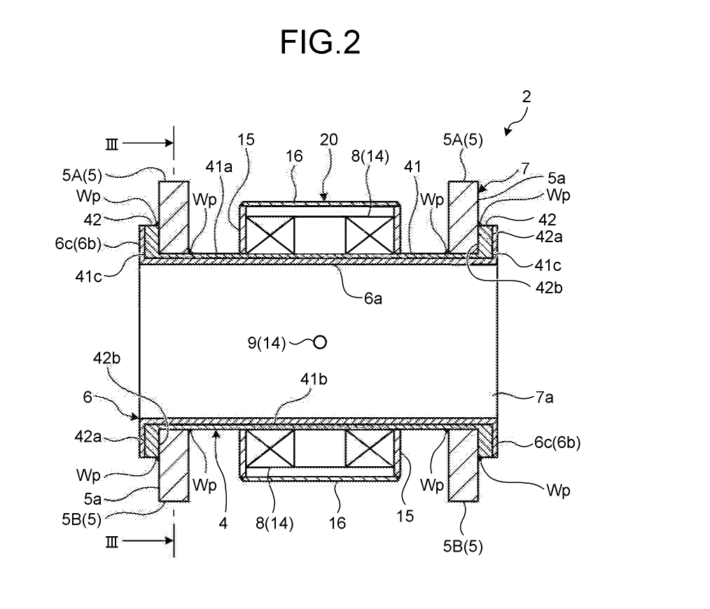

In a first embodiment, as illustrated in FIG. 1, an electromagnetic flowmeter 1 includes a detector 2 and a converter 3 (a display device or an electronic device). The detector 2 includes a pipe 7 having an internal flow channel 7a and includes a detecting element 14 (see FIG. 2) that detects a fluid to be measured which flows through the flow channel 7a. The detecting element 14 includes a pair of electrodes 9, 9 to contact with the fluid to be measured (in FIG. 2, only a single electrode 9 is illustrated), and includes exciting coils 8 (coil units) housed in a case 20 of the pipe 7. The line connecting the pair of electrodes 9, 9 is substantially orthogonal to the axial center of the pipe 7 (a measurement pipe 4) (hereinafter, simply referred to as the axial center). The exciting coils 8 generate a magnetic field in the direction orthogonal to the line connecting the pair of electrodes 9, 9 and orthogonal to the axial center. The converter 3 includes a housing 10 accommodating a display 12, and a controller (not illustrated). The converter 3 is fixed on the detector 2 via a coupler 13. The coupler 13 includes a wiring (a harness or a cord) via which the converter 3 (the controller) and the detector 2 are electrically connected (the detecting element 14).

In the electromagnetic flowmeter 1, a magnetic field is generated inside the pipe 7 by the exciting coils 8. A flow of the fluid to be measured orthogonal to the magnetic field causes generation of an electromotive force in the direction orthogonal to the magnetic field and the fluid to be measured. The electromotive force from the fluid to be measured is detected by the pair of electrodes 9, 9. Then, the pair of electrodes 9, 9 transmits a detection signal according to the electromotive force to the controller of the converter 3. The controller calculates (detects) a magnitude (value) of the electromotive force from the detection signal. Moreover, the controller calculates a flow rate from the calculated magnitude of the electromotive force and displays the flow rate on the display 12 (a display screen 12a).

The display 12 includes the display screen 12a and is supported in the housing 10 in such a manner that the display screen 12a is visible. In the first embodiment, as an example, the display device 12 is contained in the housing 10 and is covered with a panel 11. Moreover, the panel 11 has a transparent (for example, colorless and transparent) cover 11a (a transmissive member, a translucent member, or a window) disposed thereon. The display screen 12a of the display device 12 is viewed through the cover 11a. The display 12 is a liquid crystal display (LCD), for example.

As an example, as illustrated in FIGS. 1 and 2, the pipe 7 includes the measurement pipe 4 (pipe), flanges 5, and a lining 6. The pipe 7 can be coupled with another pipe (a pipe to be measured, not illustrated) through which the fluid to be measured flows. The detecting element 14 and the controller detect the flow rate of the fluid to be measured from the another pipe into the pipe body 7.

As an example, the measurement pipe 4 includes a base 41 (a tubular portion) and projections 42 (flanges). The base 41 has a tubular shape (in the first embodiment, as an example, a cylindrical shape) along the axis (axial center) of the pipe 7. The projections 42 are provided at both axial ends 41c, 41c of the base 41 (see FIG. 2), and project in a direction intersecting with (in the first embodiment, as an example, orthogonal to) the axial direction. Moreover, the projections 42 are configured to expand as a flat plate and a ring (in the first embodiment, as an example, annular) in the orthogonal direction to the axial direction (radial direction).

The base 41 has an outer face 41a (outer periphery, outside face, face opposite the flow channel 7a, or a first face) and an inner face 41b (inner periphery, inside face, face closer to the flow channel 7a, or a second face). The case 20 (the exciting coils 8) and the flanges 5 are provided on the outer face 41a of the measurement pipe 4 (the base 41) while the pair of electrodes 9, 9 and the lining 6 are provided on the inner face 41b of the measurement pipe 4 (the base 41). Each projection 42 includes an end face 42a (face opposite the flange or a first face) and an end face 42b (face closer to the flange 5 or a second face). As an example, the measurement pipe 4 can be made from a nonmagnetic material such as SUS (stainless steel).

As an example, the case 20 includes a pair of end plates 15, 15 and covers 16. The pair of end plates 15, 15 are provided with a spacing along the axis of the measurement pipe 4 (the base 41) and are oriented in a direction intersecting with (in the first embodiment, as an example, orthogonal to) the axial direction. For example, the end plates 15 can be secured (joined) onto the outer face 41a of the base 41 by welding. The covers 16 are disposed lateral to the exciting coils 8, opposing the base 41, and cover the exciting coils 8. The covers 16 can be secured (joined) on the outer peripheries of the end plates 15 by welding.

The lining 6 includes, as an example, a tubular portion 6a (a first portion) and flare portions 6b (second portions). The tubular portion 6a is a tubular (in the first embodiment, as an example, cylindrical) along the inner face 41b of the base 41, and covers the inner face 41b. The inner face of the tubular portion 6a forms the flow channel 7a. The flare portions 6b are circular (in the first embodiment, as an example, plate-like and annular) along the end faces 42a of the projections 42, and cover the end faces 42a. The flare portions 6b are provided at both axial ends of the tubular portion 6a and project in a direction intersecting with (in the first embodiment, as an example, orthogonal to) the axial direction. Thus, the flare portions 6b cover the respective projections 42 from outside axially.

Moreover, the flare portions 6b each include an end face 6c which opposes the end face 42a of the corresponding projection 42 and forms the outer face of the pipe 7. As an example, the lining 6 extends across the base 41 and the projections 42. The tubular portion 6a and the flare portions 6b of the lining 6 protect the inner face 41b of the base 41 and the ends face 42a of the projections 42. The lining 6 can be made from a synthetic resin material such as fluorine contained resin.

As an example, the flanges 5 have a circular shape (in the first embodiment, as an example, an annular shape) along the outer face 41a of the base 41. The flanges 5 are provided at both axial ends 41c of the measurement pipe 4 (the base 41). The pair of flanges 5, 5 may be simply referred to as the flange 5 when they do not need to be discriminated.

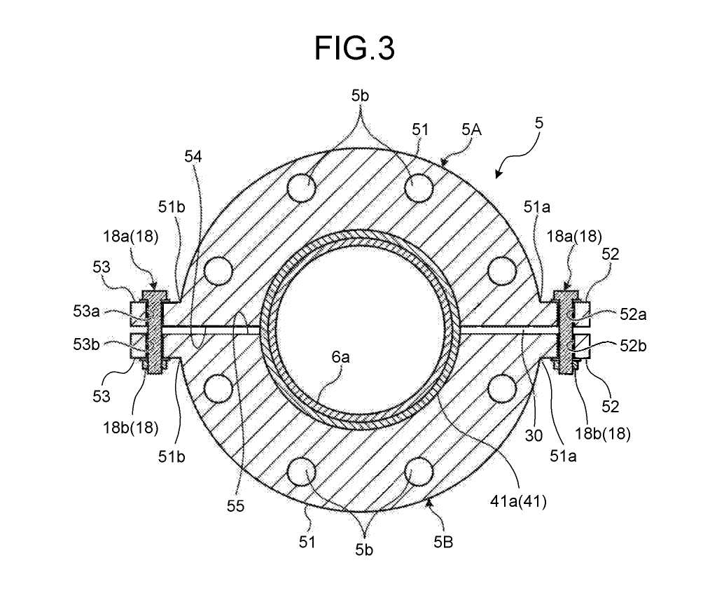

The flange 5 has an end face 5a (a face or a joint face) with which an object to join (a flange of another pipe coupled with the pipe 7) is overlapped or which opposes the object. Moreover, the flange 5 includes a plurality of holes 5b (mount holes) that pass through the flange 5 in the axial direction. As illustrated in FIG. 3, the holes 5b are provided at a constant interval (at any interval) along the circumference of the flange 5 at a plurality of (any number of) positions. Fasteners (such as bolts, not illustrated) are inserted into the holes 5b for joining the pipe 7 with the object (the flange of another pipe coupled with the pipe 7). As an example, the flange 5 can be made from a metallic material such as SUS (stainless steel).

Moreover, each flange 5 includes a plurality of members. More particularly, as illustrated in FIGS. 1 and 3, as an example, the flange 5 includes a first member 5A and a second member 5B which are two equal divisions of the flange 5 along the plane passing on the central axis of the pipe 7. Thus, the first member 5A and the second member 5B have the same shape.

As illustrated in FIG. 3, the first member 5A as well as the second member 5B each include a base 51, a pair of protrusions 52 and 53, and end faces 54 and 55. The base 51 has an arc-like shape along the outer face 41a of the measurement pipe 4 (the base 41). The protrusion 52 is provided on one circumferential end 51a of the base 51 and protrudes outward radially from the base 51. The protrusion 53 is provided on the other circumferential end 51b of the base 51 and protrudes outward radially from the base 51. The end face 54 and the end face 55 are overlapped on (face) each other. The end face 54 and the end face 55 extend across the base 51 and the pair of protrusions 52 and 53. The protrusion 52 and the protrusion 53 include holes 52a and 52b (mount holes) and holes 53a and 53b (mount holes), respectively. The holes 52a and 52b pass through the protrusion 52 in a direction intersecting with (in the first embodiment, as an example, orthogonal to) the protrusion 52. The holes 53a and 53b pass through the protrusion 53 in a direction intersecting with (in the first embodiment, as an example, orthogonal to) the protrusion 53.

The first member 5A and the second member 5B are integrated with each other with fasteners 18 (in the first embodiment, as an example, bolts 18a and nuts 18b). More particularly, the first member 5A and the second member 5B are overlaid on the end faces 42b of the projections 42 and are positioned and partially fixed to the base 41 and the projections 42 by spot welding (Wp represents the spot welding positions, see FIG. 2). Then, the first member 5A and the second member 5B are integrated with each other by inserting the bolts 18a into the holes 52a and 52b of the protrusion 52 and the holes 53a and 53b of the protrusion 53 and fastening the nuts 18b. In the first embodiment, as illustrated in FIG. 3, there is a certain gap 30 between the first member 5A and the second member 5B, extending in the direction connecting the protrusion 52 and the protrusion 53 while the end face 54 and the end face 55 are overlapped. Hence, according to the first embodiment, as an example, manufacturing variations (dimensional variations) can be eliminated. Therefore, as an example, as compared to no gap 30 provided, the binding force of the fasteners 18 can be reliably exerted, leading to more firmly integrating the measurement pipe 4 and the flanges 5 (the first members 5A and the second members 5B).

Moreover, in the first embodiment, as illustrated in FIG. 2, at the time of attaching the flange 5 to the measurement pipe 4, the first member 5A and the second member 5B are positioned and partially fixed to the base 41 and the projections 42 by spot welding (at the welding positions Wp). Hence, according to the first embodiment, as an example, the first member 5A and the second member 5B can be attached to the measurement pipe 4 by a simpler, smoother, or more accurate work.

As described above, in the first embodiment, as an example, the flanges 5 each include the first member 5A and the second member 5B that are integrated with the measurement pipe 4 with the fasteners 18. Hence, according to the first embodiment, as an example, as compared to the conventional configuration in which the flanges 5 are attached to the measurement pipe 4 by full-circled welding, the flanges 5 can be more easily attached to the measurement pipe 4. Moreover, according to the first embodiment, as an example, a plurality of pipes 7 (electromagnetic flowmeters 1) having different specifications can be obtained by joining a single measurement pipe 4 with the flanges 5 having different specifications. That is, the measurement pipe 4 can be commonly used for the plurality of pipes 7 (electromagnetic flowmeters 1) having different specifications. This can accordingly reduce the manufacturing costs of the electromagnetic flowmeters 1, as an example. Furthermore, as compared to the flanges attached to the measurement pipe 4 by full-circled welding, thermal effects on the lining 6 can be easily reduced.

In the first embodiment, as an example, each flange 5 (the first member 5A and the second member 5B) is attached to the measurement pipe 4 with the fasteners 18. Because of this, the flanges 5 can be advantageously attached to the measurement pipe 4 (the base 41) after the molding of the lining 6. Conventionally, for attaching the flanges 5 by full-circled welding, with the thermal effects on the lining 6 taken into account, the flanges 5 need to be attached to the measurement pipe 4 (the base 41) before the molding of the lining 6. In this case, for example, if no pipes 7 matching the standard (size) of the object to join (the flanges of another pipe coupled with the pipe 7) are available, a new pipe 7 has to be prepared by integrating as the measurement pipe 4 with the flanges 5. This likely results in a relatively longer manufacturing lead time (standby period). In this regard, according to the first embodiment, the flanges 5 can be attached to the measurement pipe 4 (the base 41) after the lining 6 is formed on the measurement pipe 4. This can advantageously reduce the manufacturing lead time and decrease the number of products in progress in stock. Hence, according to the first embodiment, as an example, the manufacturing time and costs for the electromagnetic flowmeter 1 can be easily reduced.

Moreover, in the first embodiment, as an example, the measurement pipe 4 includes the base 41 and the projections 42 provided at the ends 41c of the base 41, and the flanges 5 and the projections 42 are overlaid in the axial direction. Hence, according to the first embodiment, as an example the first member 5A and the second member 5B can be inhibited from moving along the axis of the measurement pipe 4 by the projections 42. Thereby, as an example, the first member 5A and the second member 5B can be attached to the measurement pipe 4 by a simpler, smoother, or more accurate work. Moreover, as an example, the flanges 5 (the integrated first member 5A and second member 5B) can be prevented from coming off from the measurement pipe 4.

Furthermore, in the first embodiment, as an example, the lining 6 includes the tubular portion 6a (a first portion, which covers the inner face 41b of the base 41, and the flare portions 6b (second portions) which cover the projections 42 from axially outside. Hence, according to the first embodiment, as an example, the sealing between the flanges 5 and the object to join (the flanges of another pipe coupled with the pipe 7) can be easily enhanced by the flare portions 6b.

The first embodiment has exemplified the wetted electromagnetic flowmeter 1 in which the pair of electrodes 9 contacts with the fluid to be measured. However, the electromagnetic flowmeter should not be limited thereto, and can be of a non-wetted type in which the pair of electrodes 9 does not contact with the fluid to be measured.

Moreover, in the first embodiment, although the first member 5A and the second member 5B are positioned with respect to the measurement pipe 4 by spot welding, the spot welding is not always necessary. Unlike full-circled welding, spot welding is partial welding, therefore, it will thermally affect the lining 6 less even if the lining 6 is already provided on the measurement pipe 4.

### Second Embodiment

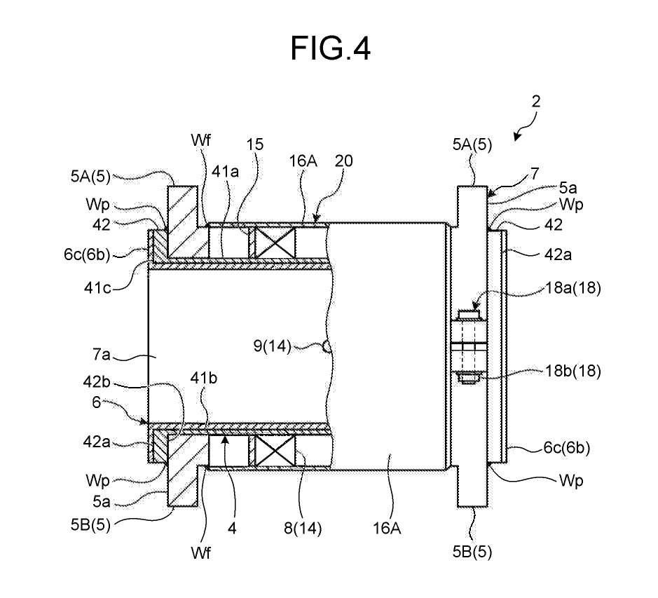

An electromagnetic flowmeter illustrated in FIG. 4 according to a second embodiment has the same configuration to the electromagnetic flowmeter 1 according to the first embodiment. Hence, the second embodiment can also achieve the same results (effects) based on the same configuration.

However, in the second embodiment, as an example, as illustrated in FIG. 4, covers 16A extend along the axis of the measurement pipe 4 to connect to the flanges 5. More particularly, in the second embodiment, as an example, the covers 16A are secured with the flanges 5 (the first members 5A and the second members 5B) by full-circled welding (Wf represents the full-circled welding positions). Hence, according to the second embodiment, as an example, at the time of joining the object (the flanges of another pipe coupled with the pipe 7) and the flanges 5, the load applied on the flanges 5 can be transferred to the covers 16A. Accordingly, as an example, it is able to suppress an increase in the stress on the flanges 5 due to the join with the object (the flanges of another pipe coupled with the pipe 7). Moreover, since the full-circled welding positions Wf are separated from the measurement pipe 4, it is advantageous that the lining 6 is subjected to less thermal effects. Furthermore, owing to the full-circled welding, water or foreign particles are prevented from entering the gaps between the covers 16A and the flanges 5.

### Third Embodiment

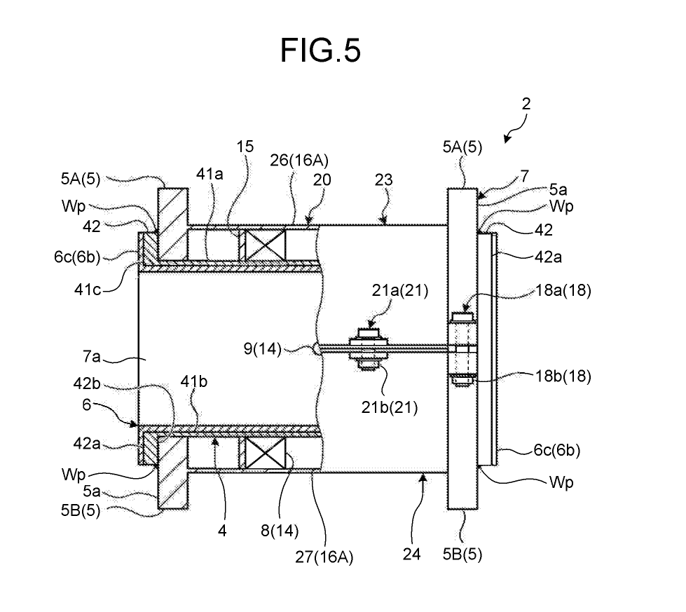

An electromagnetic flowmeter illustrated in FIG. 5 according to a third embodiment has the same configuration to the second embodiment. Hence, the third embodiment can also achieve the same results (effects) based on the same configuration.

However, in the third embodiment, as an example, as illustrated in FIG. 5, the covers 16A are integrated with the flanges 5. More particularly, in the third embodiment, as an example, the pipe 7 includes a first member 23 and a second member 24. The first member 23 is made of the first members 5A of the flanges 5 and a first cover member 26 of the cover 16A integrated with each other. Similarly, the second member 24 is made of the second members 5B of the flanges 5 and a second cover member 27 of the cover 16A integrated with each other. Herein, for example, the first member 23 and the second member 24 are cast elements (die-cast elements) made by casting (die-casting) a metallic material. Moreover, the first member 23 and the second member 24 are two equal divisions of the flanges 5 and the covers 16A along the plane passing on the central axis of the pipe 7. Thus, the first member 23 and the second member 24 have the same shape. Furthermore, in the third embodiment, the first member 5A and the second member 5B are joined with the fasteners 18, and the first cover member 26 and the second cover member 27 are joined with fasteners 21 (in the third embodiment, as an example, bolts 21a and nuts 21b) to integrate the first member 23 with the second member 24. Hence, according to the third embodiment, as an example, since the covers 16A and the flanges 5 are integrated with each other, welding of the cover s 16A and the flanges 5 is omissible during the assembly. This may accordingly lead to reducing the manufacturing lead time. Moreover, as an example, the integrated covers 16A and flanges 5 can contribute to improving the rigidity and strength of the pipe 7.

While certain embodiments of the invention have been described, the embodiments have been presented by way of example only, and are not intended to limit the scope of the inventions. Indeed, the novel embodiments described herein may be embodied in a variety of other forms, and various omissions, substitutions, combinations and changes may be made without departing from the spirit of the inventions. The above embodiments are included in the scope and spirit of the invention and in the accompanying claims and their equivalents. Moreover, regarding the constituent elements, the specifications (structure, type, direction, shape, size, length, width, thickness, height, number, arrangement, position, material, etc.) can be suitably modified. For example, an inclusion (a cushioning member or a sealing member) can be placed in the gap between the first member and the second member or between the first cover member and the second cover member.

1. An electromagnetic flowmeter comprising:
a pipe through which a fluid to be measured flows;
a detector that detects the fluid to be measured; and
a flange including a plurality of members, the members being integrated with the pipe with a fastener while surrounding an outer periphery of the pipe.

2. The electromagnetic flowmeter according to claim 1, wherein
the detector includes a coil, the coil being provided on an outer face of the pipe,
the electromagnetic flowmeter further comprising a cover connected to the flange to cover one side of the coil, the side opposite the pipe.

3. The electromagnetic flowmeter according to claim 2, wherein the cover and the flange are welded to each other.

4. The electromagnetic flowmeter according to claim 2, wherein the cover and the flange are integrated with each other.

5. The electromagnetic flowmeter according to claim 1, wherein
the pipe includes
a tubular base extending in an axial direction, and
a projection provided at an axial end of the base and projecting in a direction intersecting the axial direction, and
the projection and the flange are overlaid in the axial direction.

6. The electromagnetic flowmeter according to claim 5, further comprising a lining including
a first portion that covers an inner face of the base, and
a second portion continuous with the first portion, the second portion covering the projection from axially outside.

7. The electromagnetic flowmeter according to claim 2, wherein
the pipe includes
a tubular base extending in an axial direction, and
a projection provided at an axial end of the base and projecting in a direction intersecting the axial direction, and
the projection and the flange are overlaid in the axial direction.

8. The electromagnetic flowmeter according to claim 3, wherein
the pipe includes
a tubular base extending in an axial direction, and
a projection provided at an axial end of the base and projecting in a direction intersecting the axial direction, and
the projection and the flange are overlaid in the axial direction.

9. The electromagnetic flowmeter according to claim 4, wherein
the pipe includes
a tubular base extending in an axial direction, and
a projection provided at an axial end of the base and projecting in a direction intersecting the axial direction, and
the projection and the flange are overlaid in the axial direction.
